(19) United States
(12) Patent Application Publication
(10) Pub. No.: US 2008/0004911 A1
(43) Pub. Date: Jan. 3, 2008

(54) SYSTEM AND METHOD FOR PROCESSING HEALTH INFORMATION

(76) Inventors: Pierre LaPlante, Long Valley, NJ (US); Ken Birnbaum, Stewartsville, NJ (US); Patrick Nats, Highlands Ranch, CO (US)

Correspondence Address: DIEHL SERVILLA LLC, 77 BRANT AVE, SUITE 210, CLARK, NJ, 07066, US

(21) Appl. No.: 11/427,978

(22) Filed: Jun. 30, 2006

(51) Int. Cl. G06F 19/00

(52) U.S. Cl. 705/3

(57) ABSTRACT

A system and method for managing work flow in a hospital emergency department providing care for a plurality of patients are disclosed. The system includes a server, one or more portable wireless communication devices and application software that can run on the server. The application software maintains a database or other information storage means having information about the plurality of patients and providing communications with the one or more communication devices. Communications are provided in an automatic, persistant and redundant manner.

### BACKGROUND OF THE INVENTION

The present invention relates to systems and methods for processing information relating to health care environments, and more particularly to emergency departments in hospitals.

The emergency department in hospitals presents some of the most stressful situations a physician or health worker can face. Dealing with the life threatening situations can be very difficult and stressful. Present systems and methods to process information relating to a patient's care in the emergency department do not adequately assist the health care professional's job of providing care to patients in emergency departments.

From the patient's perspective, the emergency department experience is not pleasant. The time to treat and process patients is typically too long and involves too much waiting. In the case of a true emergency, this can be life threatening. In other cases involving health situations that are not life threatening, the waiting can be extremely frustrating. Further, most patients perception is that they are waiting for no good reasons. In fact, much of the waiting is due to inefficiencies in processing information relating to patient care in emergency department situations.

The flow of information in the emergency department environment also is not conducive to effective treatment and processing of patients. The timely availability of important information would improve the treatment of patients is not available to a health care provider. It would also improve the efficiency of a hospital's emergency department.

Accordingly, new and improved systems and methods for processing information in a hospital emergency department are needed.

### SUMMARY OF THE INVENTION

In accordance with one aspect of the present invention, systems and processes for managing work flow in a hospital emergency department providing care for a plurality of patients is provided.

In accordance with one aspect of the present invention, a system for managing work flow in a hospital emergency department providing care for a plurality of patients is provided. The system includes a server, one or more wireless communication devices, and an application software module that can run on the server. The application software module preferably maintains a database having information about the plurality of patients and automatically provides communications with the one or more communication devices.

In accordance with a further aspect of the present invention, the communications are automatically provided when the database changes. In accordance with another aspect of the present invention, communications are automatically provided when a status of one of the plurality of patients changes.

In accordance with another aspect of the present invention, the application software module time stamps all of the communications with the one or more wireless communication devices.

The one or more communication devices are preferably portable. The portable communications devices can be selected from the group including pagers, cell phones, PDAs and Blackberrys or any other portable communications device.

In accordance with a further aspect of the present invention, the communications are provided in accordance with a set of rules. The set of rules can provide, for example, a triage analysis of the information about the plurality of patients. The triage analysis can define a response time to one of the plurality of patients and an order is sent to one of the one or more portable communication devices that specifies the response time. Additionally, the set of rules can define activity levels.

Further, the set of rules can be a function of the communications between the application software module and the one or more communication devices.

In accordance with a further aspect of the present invention, communications are provided in accordance with a persistence interval if an expected communication is not received. This means that communications that are not satisfactorily responded to are repeated at a pre-defined, user selected interval. The interval depends on the type of communication.

In accordance with another aspect of the present invention, communications are provided in accordance with a back up redundancy protocol if an expected communication is not received. This means that a communication will be sent to more communication terminals or health care providers and/or to different communications terminals or different health care providers with follow up communications if the expected communication is not received or acknowledged by either the device or the clinician.

A corresponding method of managing work flow in a hospital emergency department providing care for a plurality of patients is also provided.

### DESCRIPTION OF THE DRAWINGS

FIG. 1 illustrates a block diagram of the system in accordance with one aspect of the present invention.

FIG. 2 illustrates a process in accordance with an aspect of the system and method of the present invention.

FIG. 3 illustrates a set of rules that govern communications provided by the communications of the present invention.

FIGS. 4 to 10 illustrate a case study of the processing of a single patient in accordance with further aspects of the system and methods of the present invention.

FIGS. 11 to 13 is an example of processing of a patient in accordance with yet further aspects of the system and methods of the present invention.

### DESCRIPTION OF A PREFERRED EMBODIMENT

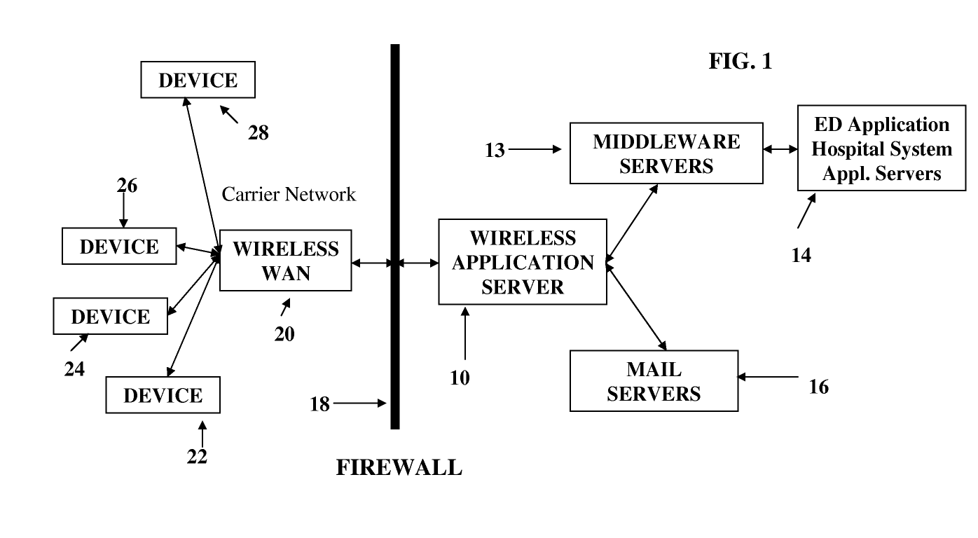

FIG. 1 illustrates a block diagram of the system in accordance with one aspect of the present invention. The system includes several servers 10, 12, 14 and 16 behind a firewall 18. While four servers are illustrated, there may be more servers or even only one server.

The server 14 includes the existing emergency department application software. It also can include the application software that implements the methods of the present invention. The application software includes computer readable code that can be run on a computer system on the server 14. The server 14 communications with an optional middleware server 12.

The middleware server 12 communicates with a wireless application server 10. A mail server 16 also communicates with the wireless application server 10. The wireless application server 10 communicates through a firewall 18 with a wireless wide area network 20, which provides communications with a plurality of communication devices 22, 24, 26 and 28. A carrier based wireless network can also be used.

Of course, there are a wide variety of server arrangements that can be used in accordance with the present invention. The arrangement will be dependent on the hospital that the system is installed in. Also, the software application that implements the present invention can be resident in any of the servers.

The communication device 22 is a Blackberry device. The communication device 24 is a PDA. The communication device 26 is a cellular telephone. The communication device 28 is a pager. Any other communication device can be used. The communication devices can be a non-portable device, such as a personal computer, or can be a portable device. Further, the communications can be provided with any of the communication devices via a hard wired connection as well. Use of the internet is also optional.

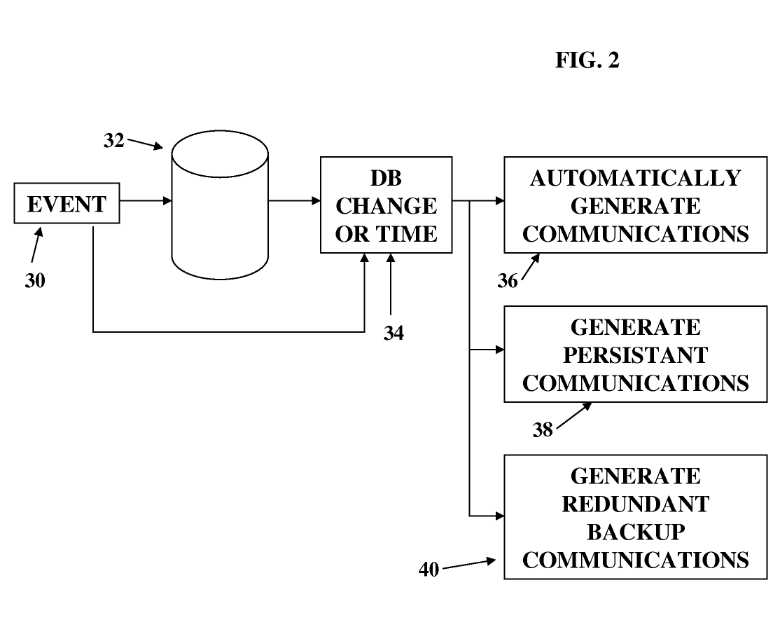

FIG. 2 illustrates a process performed in accordance with one aspect of the present invention. In step 30, an event occurs. The event could be a patient checking in, a completion of an examination, a completion of a test on a patient, a completion of a test in a lab, or any other event that may occur in an emergency department.

The results of the event 30 are entered into a database 32. The database is maintained by the application software of the present invention. The database can include existing hospital databases and can include new tables and fields generated by the processing of the present invention. The database is preferably maintained on the main server 14, but can be maintained anywhere. Information concerning each communication sent and received by the system of the present invention is stored in the database. Information concerning the status of the patients is also stored in the database.

In accordance with one aspect of the present invention, an application software module that can run on the server and that interfaces with the database is loaded on the server 14. In accordance with one aspect of the present invention, at least some of the communications with the one or more communication devices 22 to 28 are automatically provided by the application software module.

In step 34, changes in the database are monitored. It is known in the field of databases to monitor for changes in the database. When a change is detected, generally as a result of an event, a rule base is consulted and communications are automatically generated in step 36 to one of the communication devices 22 to 28.

In step 34, communications can also be generated to the communication devices 22 to 28 in response to time. If an expected event does not happen within a predetermined time interval, then another communication can occur. The system of the present invention can monitor whether the communications occur in a predetermined time frame. One further type of communication is a persistence communication which happens at the end of a predetermined time interval if an expected event does not occur. The time interval is user selectable and further depends on the type of event that is expected. If the event is a high emergency event, the time interval will be shorter than if the event has a low priority level. Thus, when an expected event does not occur, the system of the present invention detects this in step 34 and causes a persistence communication to occur in step 38. This communication in step 38 is generally a re-communication of a message previously transmitted in step 36 and is made to ensure a response to a situation is made.

The passage of time without the detection of an expected event in step 34 can also generate another type of communication in step 40. This is a redundant, back-up communication. Generally, when a second, repeated communication does not generate an expected event, the system of the present invention causes a redundant communication to occur in step 40. Depending on the situation and the rules of communication set up by the system of the present invention, a redundant communication in step 40 may involve retransmitting the communication to the same communication devices as well as sending the communication to additional communication devices to ensure that the communication has been received. Thus, a redundant communication in step 40 may simply involve transmitting the communication to more people and more communication devices 22 to 28. It may also involve transmitting the communication to supervisors of the people that received the original communication. To do this, the system of the present invention maintains a list of which communication devices 22 to 28 are assigned to which people.

As shown in FIG. 2, the system in step 34 can monitor the database for changes. Alternatively, a processor in one of the servers could directly monitor the event entries and the communications to implement the communications in accordance with the present invention.

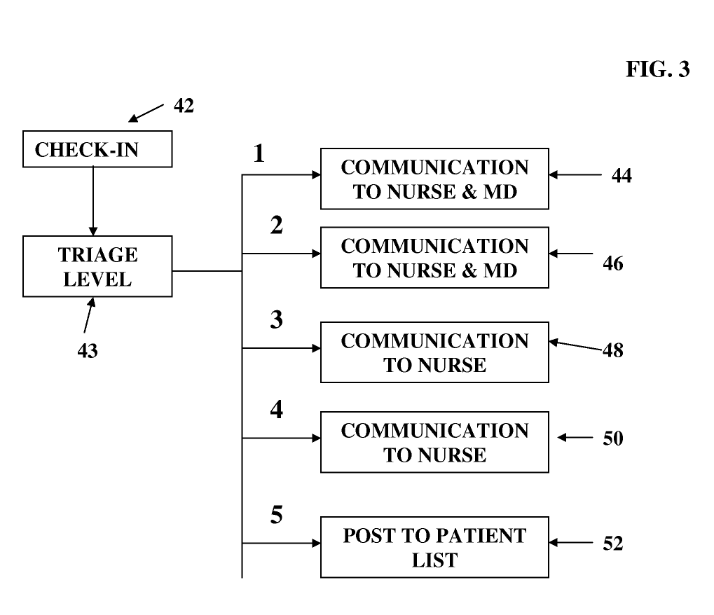

FIG. 3 illustrates a rule base method in accordance with a further aspect of the present invention. The illustrated rule base concerns the event of a patient checking into an emergency department, as shown in step 42. In step 43, a triage analysis is performed. There are generally five levels of triage. In the illustrated rule base of FIG. 3, if a level 1 or a level 2 triage is determined, the patient is in considerable danger and a communication would be sent to a nurse and a doctor. If no response is detected in thirty seconds, then another persistent communication is sent to the nurse and the doctor. After another thirty seconds, if no response is detected, then a redundant back up communication is sent to the floor nurse and to another doctor, as well as to the original nurse and doctor. Of course, the intervals can be user selectable, and any rule base desired can be implemented by the system of the present invention.

If a triage level 3 or 4 is determined on patient check in, the patient is in much less danger and the system of the present invention, in accordance with the rule base illustrated in FIG. 3 will send a communication only to a nurse. If a triage level 5 is determined, the system merely adds the patient to a care giver's patient list.

Thus, the present invention provides automated, persistent and redundant communications between a database and health care providers. For example, when a patient first arrives, a physician and a nurse are automatically notified once the patient is checked in. Accordingly, the physician and the nurse can immediately react to the patient's presence in the emergency department. Both the physician and the nurse are expected to acknowledge the automatic communication they receive from the system of the present invention. Thus, the system can keep track of whether the physician and the nurse know of the patient's presence. Further, when the physician and the nurse respond to the patient's presence, they are expected to send a communication to the database with the results of the examination of the patient. Thus, the system can keep track of the response times in the emergency department. The system and process of the present invention provide an efficient flow of information that improves the care provided to patients in emergency departments.

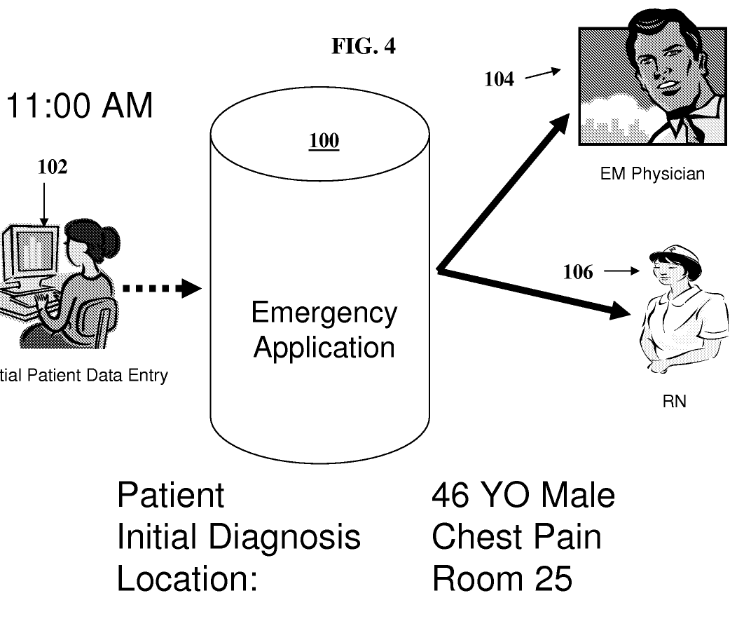

FIGS. 4 to 10 illustrate a case study of the processing of a single patient in accordance with further aspects of the system and methods of the present invention. In FIG. 4, a patient has checked into an emergency department at 11:00AM. The information relating to the patent is entered into a database 100. The time tag of 11:00AM is also entered. The information relating to the patient is entered by an administrator 102. The information includes the patient's name, age, symptoms, health insurance information and location in the emergency department.

The system of the present invention automatically sends a communication to one or more persons on a communication device possessed by that person, depending on the rule base, as previously discussed. In the case of FIG. 4, a triage level 1 has been determined to exist, and the system of the present invention sends a communication to a doctor 104 and a nurse 106. The time of the communications to the doctor 104 and nurse 106 are preferably entered into the database 100. The devices possessed by the doctor 104 and the nurse 106 can automatically acknowledge receipt of the communication by sending a message back to the servers. The time of the receipt acknowledgment by the communication device is also preferably entered into the database 100.

The communication preferably includes an initial order. The order will be based on the initial diagnosis. In this case, the order to the nurse 106 may include the task of performing an initial examination of the patient. The nurse 106 and the physician 104 both preferably acknowledge receipt of the communication, and the time stamped receipt is entered into the database 100.

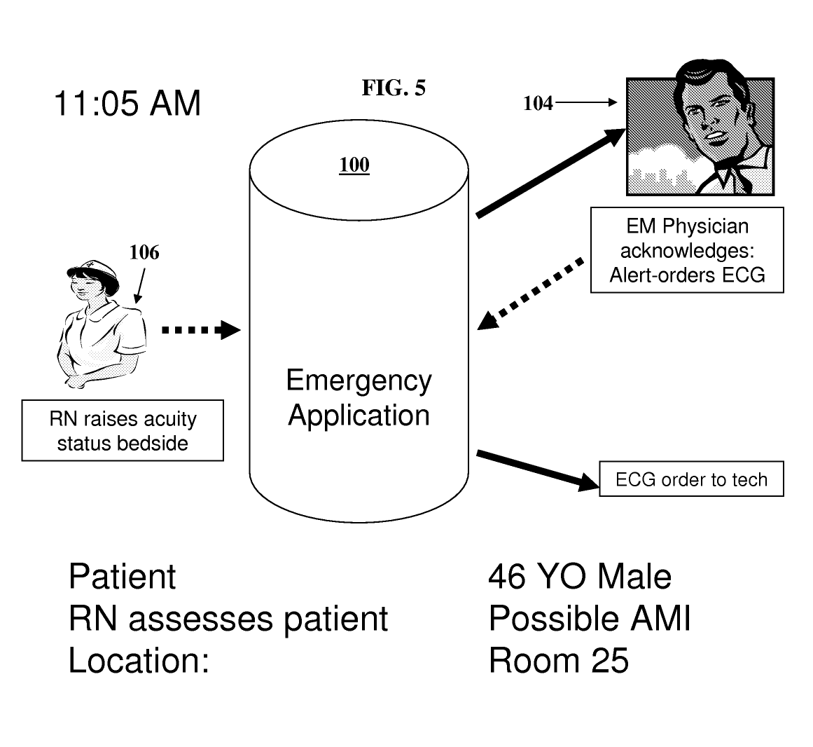

In FIG. 5, the status as of 11:05AM is indicated. The nurse 106 has performed an initial examination and has raised the acuity status of the patient, indicating a possible MI. The nurse 106 enters this information into a Blackberry, the information is transmitted to the system of the present invention and the information is stored in the database 100. All of the communications are time tagged and entered into the database 100.

The information entered by the nurse 104 is transmitted in a communication to the physician 104. The physician acknowledges receipt of the communication to the system. The physician's acknowledgement of the receipt of the communication includes a request for an EKG. Both the communication to the physician and from the physician are time stamped and stored in the database 100.

The system of the present invention, upon receiving the request for an EKG from the physician, detects a change in status in the database 100, and automatically sends an order for an EKG test to a technician. The order is sent to a technician's communication device, such as PC, a Blackberry or other portable communication device.

When the EKG is completed, the technician causes a communication from their communication device to be sent to the system and stored in the database 100. The EKG results can also be stored in the database 100. This can be accomplished either by transmission from the EKG device as the test is completed or at a later time.

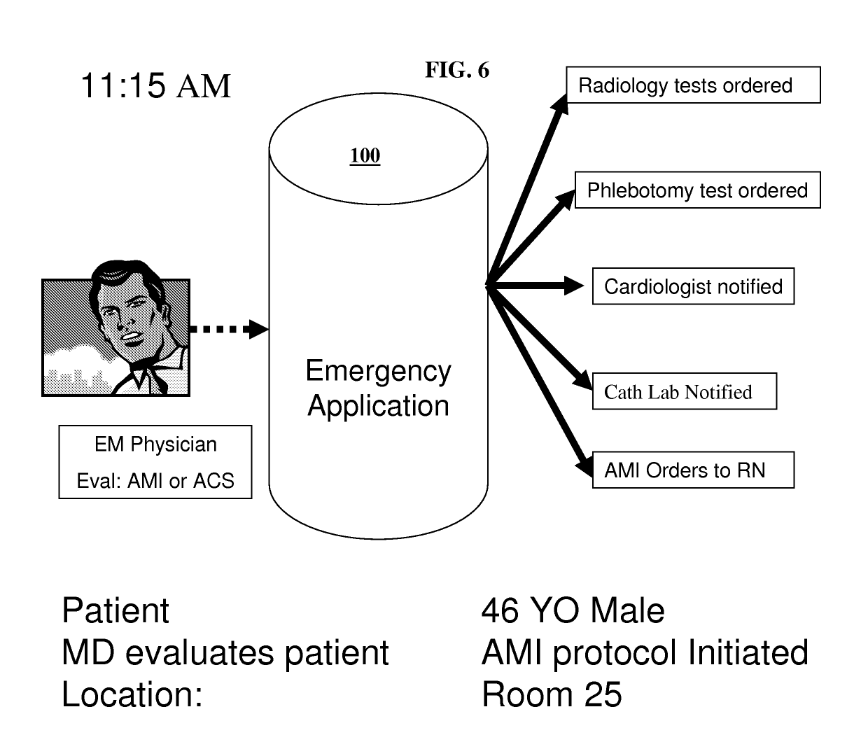

Referring to FIG. 6, which indicates the status at 11:15AM, the physician has reviewed the results of the test and the evaluation of the nurse. Based on the review, the physician, through a communication from a communication device 22 to 28 to the server 14, updates the status of the patient to indicate that a protocol has been initiated. The physician enters this information via a communication sent by the physician's communication device.

The system of the present invention, responds automatically to the protocol initiated by the physician. The system sends out communications requesting a series of tests. The tests include radiology, phlebotomy, and cardiology. The tests are sent to the appropriate technicians and specialists along with any other patient specific information needed. The system also automatically notifies Cath Lab and notifies the nurse. All of the communications are entered into the database 100 and time tagged, which information is also entered into the database 100.

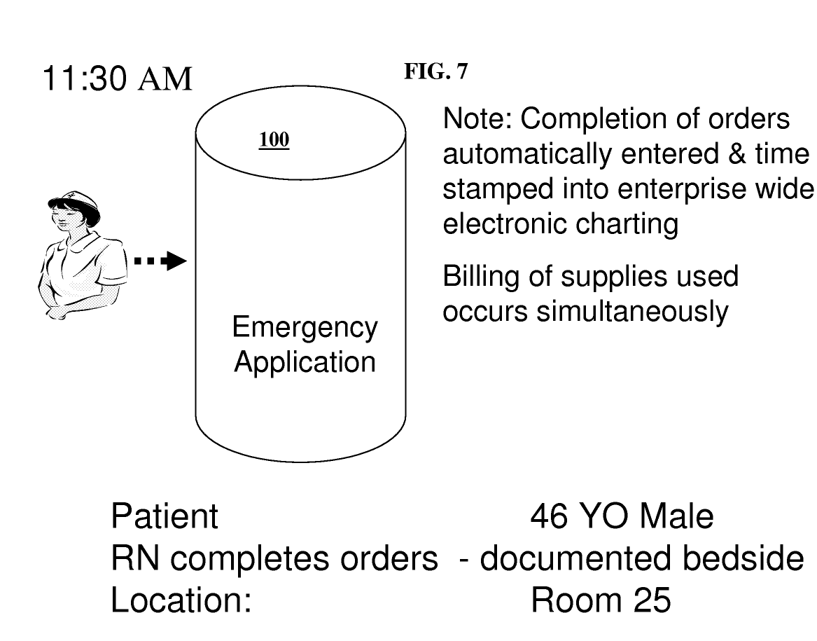

FIG. 7 indicates the status as of 11:30. As the tests ordered are completed, the technicians performing the tests send a communication to the system indicating that the test has been completed. These communications are logged into the database 100. As those communications are received, they are time stamped and the information is stored in the database 100.

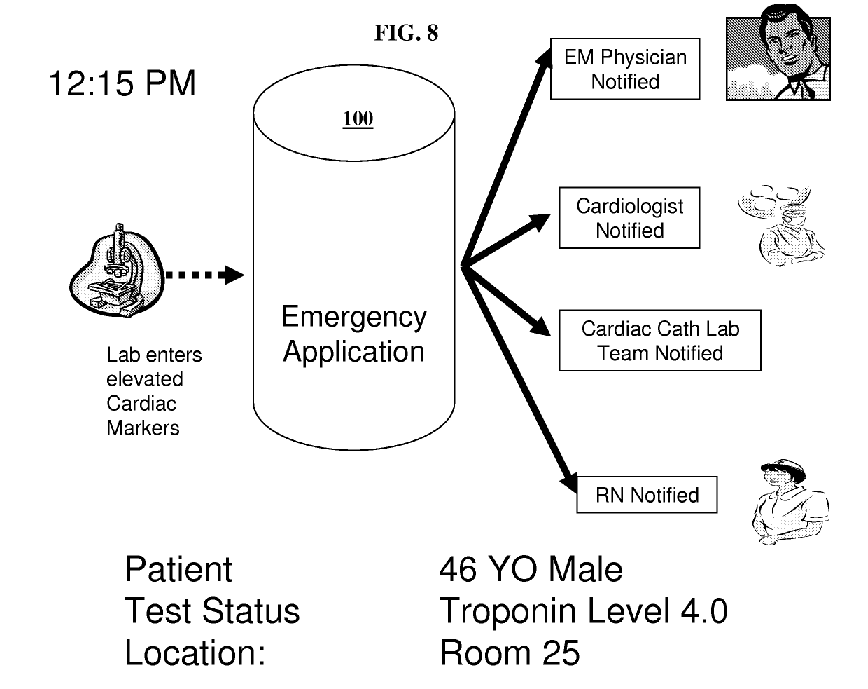

FIG. 8 illustrates the status as of 12:15AM. The lab has sent a communication to the system entering the results of the tests. The tests indicate an elevated toponin level of 4.0. This communication and the lab results are entered into the database 100, as are the time stamps for each communication. The system updates the status to indicate the elevated levels and automatically sends communications to appropriate individuals. As shown in FIG. 8, a communication is sent to the physician to notify the physician of the new status. A communication is also automatically sent to a cardiologist in accordance with a rule base. Communications are also sent to the Cardiac Cath team and to the nurse. Each of these communications are time stamped and stored in the database 100.

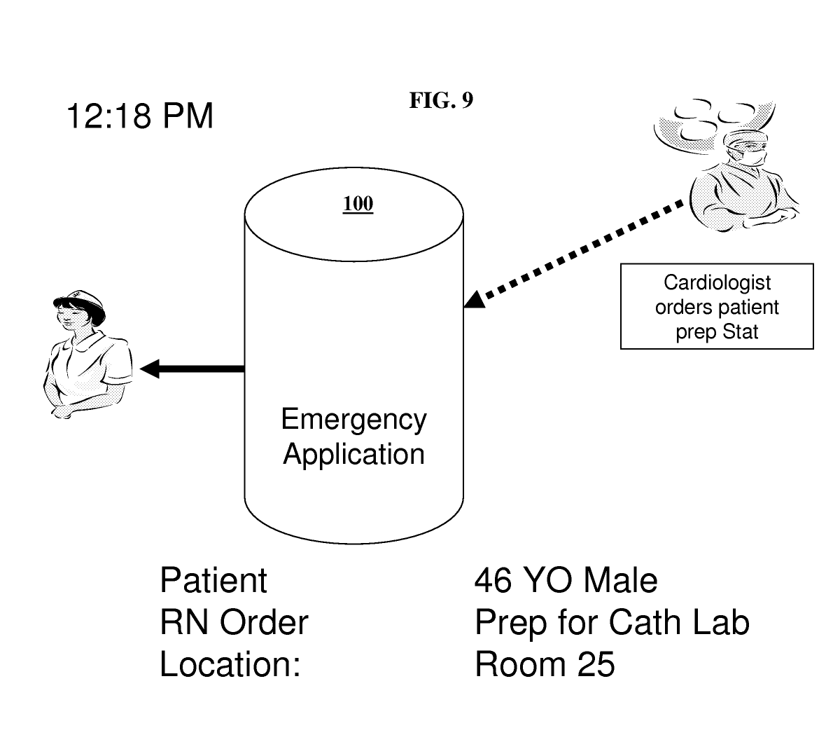

FIG. 9 illustrates the status at 12:18. Based on the status viewed on his communication device, the cardiologist has sent a communication ordering a preparation for a procedure. The communication is sent from a portable communication device such as a Blackberry. The system automatically sends a communication to the Cath Lab notifying them of a procedure to be performed. As always the communication and the associated time stamp is stored in the database 100.

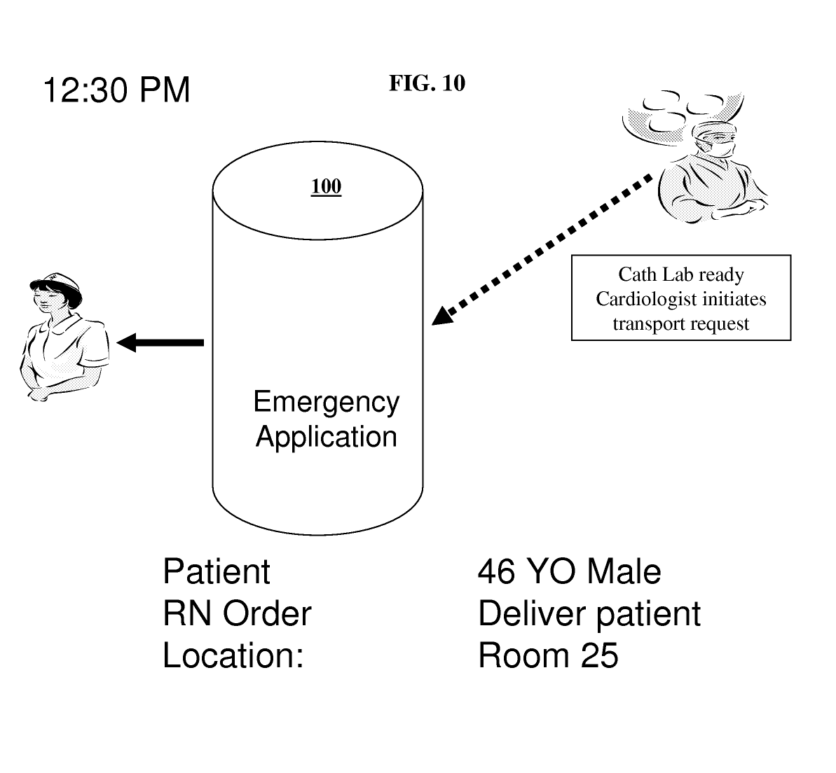

FIG. 10 illustrates the status at 12:30. The Cath Lab has prepared for the procedure and sends a communication to the system indicating this status. The system automatically sends a communication to the cardiologist indicating that the lab is ready. In response, the cardiologist sends a communication via a portable communication device to the system and the database 100 ordering the patient to be transferred to the lab.

All communications sent or received by the system of the present invention are preferably time stamped. Further, all communications sent or received are also stored in the database 100.

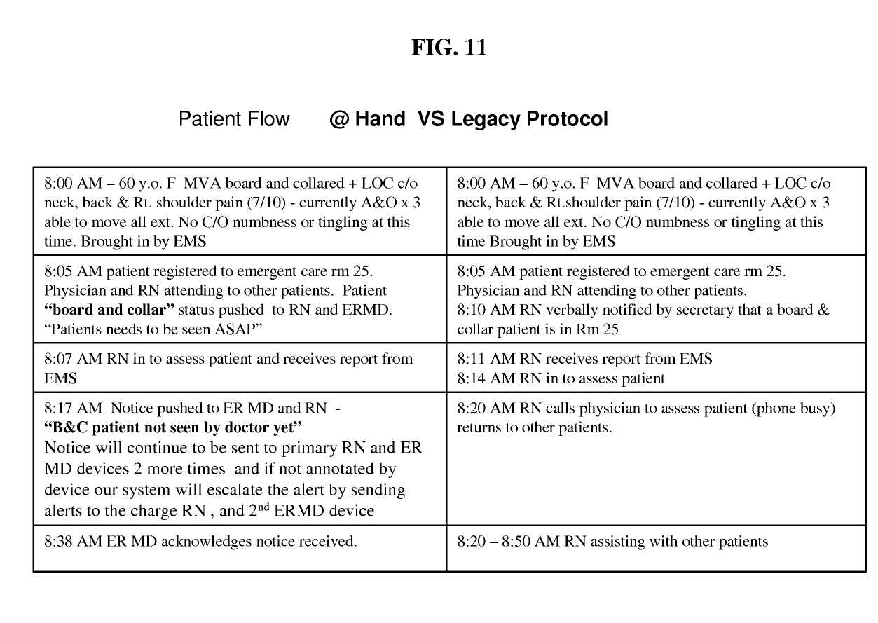

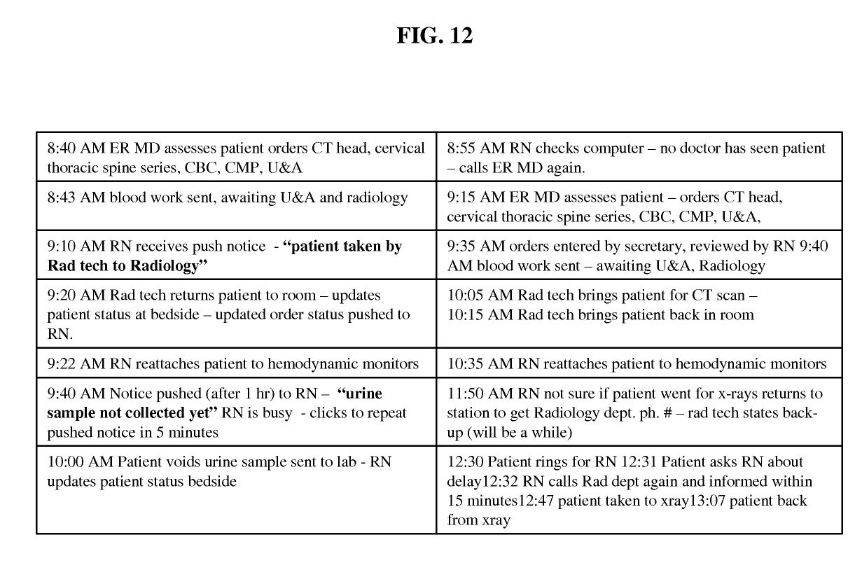

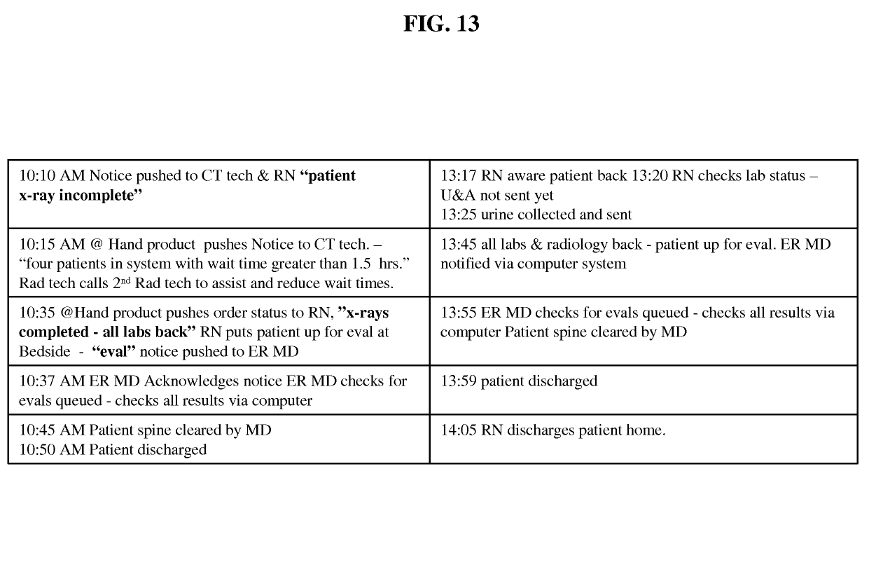

FIGS. 11 to 13 illustrate a hypothetical example of the processing of a patient with the system of the present system (on the left side) to the processing of a patient with existing systems (on the right side).

At 8:00AM a patient is checked in and at 8:05 a communication is automatically generated by the system of the present invention to a nurse and to a doctor. The communication shows a board and collar status, indicating the patient is immobilized.

At 8:07, the nurse sees the patient and sends a communication to the system indicating the visit. At 8:17, the system of the present invention determines that the patient has not been seen by a doctor yet. A message is sent to the nurse and the doctor again to remind them that the doctor needs to see the patient. The message will be sent two more times, after which the message is sent to a charge nurse and to a second doctor.

In the example of FIG. 11, the doctor acknowledges the communication and examines the patient. At 8:40, the doctor orders a series of tests and enters this in a communication to the system. At 8:43, a technician enters a communication into his or her communication device which is transmitted to the server for storage in the database 100 that indicates that blood work was sent, but that radiology tests were waiting.

At 9:10, the patient is transferred to radiology and a person assigned to transport the patient communicates that information through a communication device to the present system. At 9:20 a radiology technician returns the patient to the room and updates the patient's status in a new communication to the system. This information is also sent to the RN.

At 9:40, the system of the present invention determines that the urine sample was not collected yet, and in accordance with a rule base system, sends a communication to the nurse. The nurse sends a communication back indicating a busy status and asks that the communication be repeated in five minutes.

At 10AM, the patient provides a urine sample that is sent to the lab. This information is provided in a communication to the system. At 10:10, it is determined that the xray is incomplete and a communication is sent to x-ray technician. The solution in accordance with one aspect of the present invention determines that there is a back log of tests and a long wait time. A second technician is alerted via device to reduce the wait times. At 10:35 a communication is received that the xrays are complete. The patient is then cleared by the doctor for release and this information is communicated from the doctor's communication device to the server and database of the present invention.

It is preferred that as many health care providers as possible receive a communications device 22 to 28. For example, all clinicians, including RNs, LPNs, Nurse Practitioners, Nursing assistants, floor technicians, MDs, Radiologists and anesthesiologists preferably all receive portable communication devices that communicate with the present system. Further, the staff, including transport, housekeeping, dietary, phlebotomy, radiology technicians, patient coordinator, and ekg techs, preferably all receive portable communication devices that communicate with the present system.

The system and method of the present invention will provide a quicker and safer operation in emergency departments. The method and system of the present invention effectively provides a living and breathing emergency department facilitator. It should also provide similar results in physician's offices, other hospital environments and testing facilities.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

We claim:

1. A system for managing work flow in a hospital emergency department providing care for a plurality of patients, comprising:
a server;
one or more wireless communication devices; and
an application software module that can run on the server, the application software module maintaining a database having information about the plurality of patients and automatically providing communications with the one or more communication devices.

2. The system as claimed in claim 1, wherein communications are automatically provided when the database changes.

3. The system as claimed in claim 1, wherein communications are automatically provided when a status of one of the plurality of patients changes.

4. The system as claimed in claim 1, wherein the application software module time stamps all of the communications with the one or more wireless communication devices.

5. The system as claimed in claim 1, wherein the one or more communication devices are portable.

6. The system as claimed in claim 5, wherein the one or more portable wireless communication devices are selected from the group including pagers, cell phones, PDAs and Blackberrys.

7. The system as claimed in claim 1, wherein the communications are provided in accordance with a set of rules.

8. The system as claimed in claim 7, wherein the set of rules provide a triage analysis of the information about the plurality of patients.

9. The system as claimed in claim 8, wherein the triage analysis defines a response time to one of the plurality of patients and a order is sent to one of the one or more portable communication devices that specifies the response time.

10. The system as claimed in claim 7, wherein the set of rules define activity levels.

11. The system as claimed in claim 7, wherein the set of rules are a function of the communications between the application software module and the one or more communication devices.

12. The system as claimed in claim 1, further comprising providing communication in accordance with a persistence interval if an expected communication is not received.

13. The system as claimed in claim 1, further comprising providing communications in accordance with a back up redundancy protocol if an expected communication is not received.

14. The system as claimed in claim 12, further comprising providing communications in accordance with a back up redundancy protocol if an expected communication is not received.

15. The system as claimed in claim 13, wherein the redundancy protocol involves providing communications to an increasing number of communication devices during follow up communications.

16. The system as claimed in claim 13, wherein the redundancy protocol involves providing communications to different communications devices during follow up communications.

17. A method of managing work flow in a hospital emergency department providing care for a plurality of patients, comprising:
storing information in a database relating to a status of the plurality of patients;
determining a status of the database; and
transmitting a communication relating to the status of the one of the plurality of patients based on the status of the database.

18. The method as claimed in claim 17, wherein communication is transmitted automatically in response to a change in the status of a database.

19. The method as claimed in claim 17, further comprising providing communication in accordance with a persistence interval if an expected communication is not received.

20. The method as claimed in claim 17, further comprising providing communications in accordance with a back up redundancy protocol if an expected communication is not received.

21. The method as claimed in claim 19, further comprising providing communications in accordance with a back up redundancy protocol if an expected communication is not received.
